(19) United States
(12) Patent Application Publication
(10) Pub. No.: US 2007/0269682 A1
(43) Pub. Date: Nov. 22, 2007

(54) Ferromagnetic-backed film

(76) Inventors: Rina Lupu Matas, Kfar Vradim (IL); Uri Sharfberg, Hanita (IL); Gal Wollach, Haifa (IL); Yoash Carmi, Eilon (IL)

Correspondence Address: PEARL COHEN ZEDEK LATZER, LLP, 1500 BROADWAY 12TH FLOOR, NEW YORK, NY, 10036, US

(21) Appl. No.: 11/798,681

(22) Filed: May 16, 2007

Related U.S. Application Data
(60) Provisional application No. 60/800,421, filed on May 16, 2006.
(60) Provisional application No. 60/839,687, filed on Aug. 24, 2006.

(51) Int. Cl. B32B 15/00

(52) U.S. Cl. 428/692.1

(57) ABSTRACT

A film usable for displaying visual information is provided. The film may include a polymeric substrate and a ferromagnetic coating on a first surface of the substrate. The coating may enable attachment of the film to any magnetic surface and the second surface of the substrate may be use for carrying the visual information, such as advertisement, manually written information, scenery backdrop, wall design and the like.

### CROSS REFERENCE TO RELATED APPLICATIONS

This application claims priority from U.S. Provisional Patent Application No. 60/800,421 filed on May 16, 2006 and U.S. Provisional Patent Application No. 60/839,687, filed on Aug. 24, 2006, which are both incorporated in their entirety herein by reference.

### BACKGROUND OF THE INVENTION

Flexible printed media of different sizes are commonly used for many indoors and outdoors applications such as signage, posters, placards, advertisements, wallpapers, points of sale, surface coverage and other display and coverage applications. For many advertisements applications, there is a growing demand for printed media on sheets having a substantial size of 100 square meters and more. Other applications may use much smaller printed media. Usually, the flexible printed media is attached to a base substrate or a wall as backing to provide the mechanical strength needed for vertical display. To date, the printed media is usually attached to the backing using a pressure sensitive adhesive, or any other adhesive. The usage of adhesive makes the attachment, removal and replacement of the printed media a difficult and time-consuming process that usually requires specific expertise, especially when large surfaces are covered. It is therefore desirable to have media that is easy to frequently install, remove and replace.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic cross section illustration of a ferromagnetic-backed film according to embodiments of the present invention.

FIG. 2 is a schematic cross section illustration of a film according to other embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

According to embodiments of the present invention, a printable ferromagnetic-backed medium is herein described. The medium may comprise a flexible polymeric film, back-coated with a mixture of a polymeric resin which may include a fine powder of a ferromagnetic material. Non-limiting examples of such materials may be ferromagnetic minerals like Magnetite (Fe₃O₄) or ferromagnetic metals like Iron (Fe), Nickel (Ni) or Cobalt (Co), or other suitable materials. The ferromagnetic coating may enable the film to be adequately attached to any suitable magnetic surface. Accordingly, a printed ferromagnetic-backed film may be easily attached to a magnetic surface for display or signage and likewise may be easily removed from the surface as desired. It should be understood that the ferromagnetic-backed film may be in a form of a roll or sheets of film.

A suitable magnetic surface for use with the ferromagnetic-backed film may include a full magnetic surface or a surface having both magnetic and non-magnetic areas. For example, the surface may include stripes of thin magnetic sheets, or any other pattern of magnetic and non-magnetic surface areas, so long as the total magnetic surface area is adequate to attach a desired ferromagnetic-backed film to the magnetic surface. The magnetic surface may be fixed to a wall or a display structure. Alternatively, the magnetic surface may be in a form of a movable board.

According to embodiments of the present invention, the ferromagnetic-backed film may be useful, among other things, for indoor or outdoor display of advertising materials of substantial size. Another application may involve small-sized ferromagnetic-backed sheets for displaying visual information during presentations. It should be understood to a person skilled in the art that, according to embodiments of the present invention, the ferromagnetic-backed film is not limited to any specific application or size and may be used for a variety of other applications and sizes. Further, the ferromagnetic-backed film may be cut to various shapes based on the requirements of the desired application. Non-limiting examples of such applications may further include full wall covering and advertisements, rotating display cabinets, sceneries (such as for theater), wall design, scenery backdrop, background graphics, notes, small publications or notes, dynamic flowchart boards and so on.

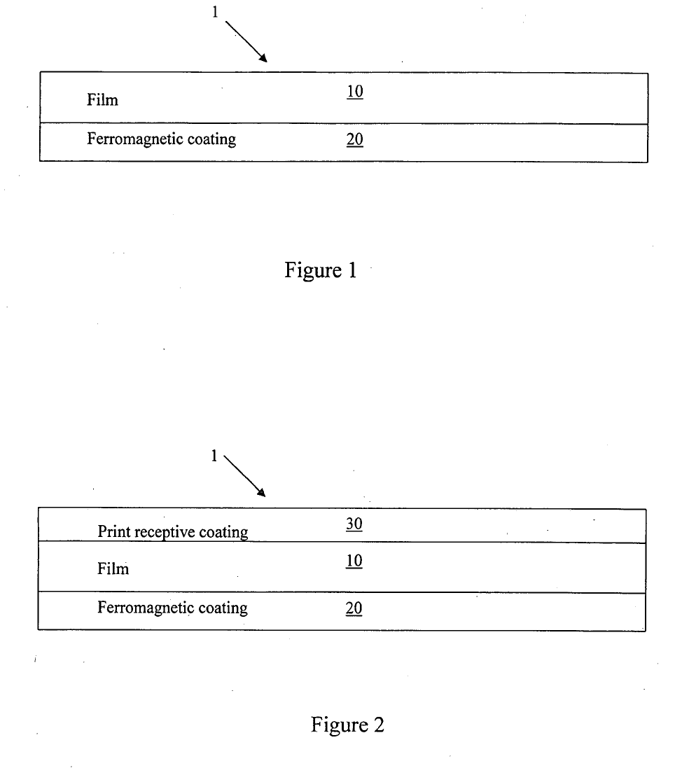

Reference is now made to FIG. 1, which is a schematic cross section illustration of a ferromagnetically coated film according to embodiments of the present invention. A ferromagnetic-backed medium 1 may comprise a film 10 and a ferromagnetic coating layer 20 applied to one surface of film 1. Coating layer 20 may be applied to film 10 using any suitable method known in the art. The ferromagnetic coating may be applied to the entire surface of the film or alternatively only to certain areas of the surface.

According to some embodiments of the present invention, film 10 may include a polymeric material. The polymeric material may be, for example, polyvinyl chloride (PVC), polyester (PET), bi-oriented polypropylene (BOPP), polypropylene (PP), polycarbonate (PC) or synthetic paper. Alternatively, according to other embodiments of the present invention film 10 may be a treated paper. Film 10 may be a flexible material processed in the form of a roll or as separate sheets.

Coating layer 20 may enable the attachment of ferromagnetic-backed film 1 to a magnetic surface. According to some embodiments of the present invention, coating layer 20 may comprise a ferromagnetic powder dispersed in a binding material. The binding material may be a polymeric resin, such as, for example, polyurethane, acrylic or polyester resin.

Reference is now made to FIG. 2, which is a schematic cross section illustration of a ferromagnetically coated film according to embodiments of the present invention. A ferromagnetic-backed medium 2 may comprise film 10 and ferromagnetic coating layer 20 applied to one surface of film 2. Ferromagnetic-backed medium 2 may further comprise a print receptive coating layer 30 applied to the other surface of film 10. Print receptive coating layer 30 is used as a primer to enable printing with certain inks that are not suitable for direct printing on film 10. Print receptive coating layer 30 may be required to enable printing by any printing method such as thermal transfer, screen printing, water-based inkjet inks, solvent based inkjet inks, eco solvent inkjet inks, flexographic, gravure etc.

Certain solvent-based inkjet inks may be used for printing on PVC films without a primer, as illustrated in FIG. 1. According to other embodiments of the present invention, ferromagnetic-backed film 1 may be used for applications that do not require previous printing. For example, film 1 may be used as a substrate to manually write on during presentations and meetings. In such cases, it is also desirable to be able to quickly replace sheets. Accordingly, one may need only supply multiple sheets of the ferromagnetic-backed film in advance in order to be adequately prepared.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A film for carrying visual information comprising:
a substrate; and
a ferromagnetic coating on a first surface of the substrate,
wherein the ferromagnetic coating enables attachment of the film to a magnetic surface for displaying the visual information.

2. The film of claim 1, wherein the substrate is polymeric

3. The film of claim 1, wherein the substrate is treated paper

4. The film of claim 1, wherein the ferromagnetic coating comprises ferromagnetic powder.

5. The film of claim 1, wherein the ferromagnetic coating the ferromagnetic coating comprises ferromagnetic minerals, ferromagnetic metals or a combination thereof.

6. The film of claim 1, wherein the substrate is a flexible polymeric substrate.

7. The film of claim 1, wherein the ferromagnetic coating is applied to at least a portion of the surface.

8. The film of claim 1 further comprising:
a print receptive coating on the second surface of the substrate.

9. The film of claim 1, wherein the film is to be used for advertisements, backdrop, wall design, or wall covering.

10. A method for displaying visual information comprising:
applying a ferromagnetic coating to a first surface of a polymeric film;
placing visual information on a second surface of the polymeric film; and
attaching the film to a magnetic surface to display the visual information.

11. The method of claim 10, wherein the ferromagnetic coating comprises ferromagnetic powder.

12. The method of claim 10 further comprising:
applying an ink receptive coating to the second surface of the polymeric film prior to placing the visual information.

13. The method of claim 10, wherein placing the visual information comprises printing the visual information directly on the second surface of the polymeric film.

14. The method of claim 10, wherein placing the visual information comprises manually placing the visual information directly on the second surface of the polymeric film.

15. The method of claim 10, wherein placing the visual information comprises printing the visual information on the ink receptive coating.
